(19) United States
(12) Patent Application Publication
(10) Pub. No.: US 2013/0069974 A1
(43) Pub. Date: Mar. 21, 2013

(54) HYBRID VIDEO HALFTONING TECHNIQUES

(71) Applicants: Jeho Lee, Palo Alto, CA (US); Manu Parmar, Sunnyvale, CA (US); Jennifer Lee Gille, Menlo Park, CA (US)

(72) Inventors: Jeho Lee, Palo Alto, CA (US); Manu Parmar, Sunnyvale, CA (US); Jennifer Lee Gille, Menlo Park, CA (US)

(73) Assignee: QUALCOMM MEMS TECHNOLOGIES, INC., San Diego, CA (US)

(21) Appl. No.: 13/480,314

(22) Filed: May 24, 2012

Related U.S. Application Data
(63) Continuation-in-part of application No. 13/422,819, filed on Mar. 16, 2012.
(60) Provisional application No. 61/535,891, filed on Sep. 16, 2011.

(51) Int. Cl. G09G 5/02

(52) U.S. Cl. 345/596

(57) ABSTRACT

This disclosure provides techniques related to halftoning video images for display on an electronic device. The techniques include adaptively selecting, on a pixel-by-pixel basis, between a mask-based dithering (MBD) and an error diffusion (ED) halftoning technique. The ED technique may be selected for halftoning pixels of an input frame of data having either a temporal change rate metric (CRM) or a spatial CRM exceeding a respective threshold. Where both the temporal CRM and spatial CRM are less than the respective thresholds, halftoning may be performed by the technique that produces a halftone value closer to a comparison halftone value of a comparison frame. The comparison frame may be a preceding frame, or an immediately preceding frame.

### CROSS-REFERENCE TO RELATED APPLICATIONS

This disclosure claims priority under 35 U.S.C. §119 to U.S. Provisional Patent Application No. 61/535,891, filed Sep. 16, 2011, entitled “METHODS AND APPARATUS FOR HYBRID HALFTONING AN IMAGE,” and assigned to the assignee hereof, and is a continuation-in-part of and claims priority under 35 U.S.C. §120 to U.S. patent application Ser. No. 13/422,819, filed Mar. 16, 2012, and entitled “METHODS AND APPARATUS FOR HYBRID HALFTONING OF AN IMAGE,” and assigned to the assignee hereof, the disclosures of which are considered part of, and are hereby incorporated by reference in, this disclosure for all purposes.

### TECHNICAL FIELD

This disclosure relates to halftoning techniques, and, more specifically, to improved techniques for halftoning video images for display on an electronic display.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. EMS can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term IMOD or interferometric light modulator refers to a device that selectively absorbs and/or reflects light using the principles of optical interference. In some implementations, an IMOD may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the IMOD. IMOD devices have a wide range of applications, and are anticipated to be used in improving existing products and creating new products, especially those with display capabilities, such as personal computers and personal electronic devices (PED's).

Electronic displays may be required to render and present image data in real time that is received on a frame by frame basis by way, for example, of a broadcast or cellular network, or over the internet, at frame rates of, for example, 30 frames per second. Such digital images are typically encoded at a relatively high bit depth of 24 bits per pixel (bpp) for color images. However, many electronic displays (such as bi-level displays or multi-level displays with only a few levels) are only capable of rendering images with a substantially lower bit-depth. Some color reflective displays, for example, analog electromechanical display devices, may render images at a bit depth of two bits per color channel (6 bpp). A process called halftoning is used to reduce high bit-depth (“continuous tone”) images to images with a more limited number of tone levels. In general, halftoning is a process for creating the perception of a continuous-tone color image with a limited number of tone levels by using knowledge of the spatio-chromatic discrimination capabilities of the human visual system.

Known halftoning techniques suitable for real time applications such as electronic display of transmitted video content include error diffusion techniques and mask-based dithering (also referred to as “screening”) techniques. Of the two methods, mask-based dithering or screening requires fewer computation resources but, for most types of image data, produces poorer quality halftones. For example, halftone images generated by mask-based dithering may have poor image quality due to pattern visibility, noisy appearance (especially in mid-tone areas), and inability to reproduce detail. Error diffusion techniques, such as those based on the Floyd Steinberg Error Diffusion (FSED) method, may produce acceptable quality halftone video output, provided that video image data varies, spatially and/or temporally. That is, for example, where a pixel is near an “edge” of an image element, or is part of a highly textured image element, or is changing temporally (due, for example, to movement of an image element), FSED-based techniques are satisfactory. However, because halftone textures are not correlated along the temporal axis, applying FSED-based methods to video data can generate objectionable artifacts. These objectionable artifacts may include temporal flickering or “boiling”, that are readily observable when the video image data relates to a static and uniform (“flat field”) image element.

### SUMMARY

The systems, methods and devices of the disclosure each have several innovative aspects, no single one of which is solely responsible for the desirable attributes disclosed herein.

One innovative aspect of the subject matter described in this disclosure may be implemented in an apparatus including an electronic display; and a display control module. The display control module may be configured to receive a plurality of input frames of video data, each input frame including a plurality of input pixels. For each input frame, the display control module may generate an output frame of video data, the output frame including a first subset of halftoned output pixels and a second subset of halftoned output pixels. The display control module may: compute a temporal change rate metric (CRM) and a spatial CRM for each input pixel; generate the first subset of output pixels by generating, using an error diffusion technique, a corresponding halftoned output pixel for each input pixel in a first subset of the input pixels, the first subset including only input pixels for which one or both of the temporal CRM and the spatial CRM exceeds a respective threshold; and generate the second subset of output pixels by generating, using a selected halftoning technique, a corresponding halftoned output pixel for each input pixel in a second subset of the input pixels, the second subset including only input pixels for which each of the temporal CRM and the spatial CRM is less than or equal to the respective threshold. The display control module may be configured to determine the selected halftoning technique by (i) computing a first halftone value using the error diffusion technique; (ii) computing a second halftone value using a mask-based dithering technique; (iii) comparing each of the first halftone value and the second halftone value to a comparison halftone value of a corresponding output pixel in a comparison frame; (iv) when the comparing indicates the second halftone value is closer to the comparison halftone value than the first halftone value, selecting, for first individual ones of the second subset of pixels, the mask-based dithering technique; and (v) when the comparing indicates the second halftone value is not closer to the comparison halftone value than the first halftone value, selecting, for second individual ones of the second subset of pixels, the error diffusion technique. The display control module may render the output frame on the electronic display to form a displayed halftone video image.

In an implementation, computing the temporal CRM of each input pixel may include comparing a halftone value of the input pixel to a halftone value of a corresponding output pixel of a comparison frame. The comparison frame may precede the input frame.

In another implementation, computing the spatial CRM of each input pixel may include comparing a data value for the input pixel to a corresponding data value for neighboring input pixels, the neighboring input pixels and the input pixel being located in a common local region. One or both of the first data value and the corresponding data value may be halftone values. The common local region may include one of a three by three pixel block, a five by five pixel block, or a seven by seven pixel block.

In a further implementation, the mask-based dithering halftoning technique may include dithering the input pixel with a mask. The error diffusion technique may include quantizing the input pixel and diffusing a first quantization error with an error diffusion filter. The first quantization error may include a second quantization error resulting from the mask-based dithering halftoning technique. The second quantization error may be computed by clipping a quantization error resulting from the mask-based dithering halftoning technique.

In yet another implementation, the apparatus may further include a processor that is configured to communicate with the electronic display, the processor being configured to process image data and a memory device that is configured to communicate with the processor. The apparatus may further include a driver circuit configured to send at least one signal to the electronic display and a controller configured to send at least a portion of the image data to the driver circuit. The apparatus may further include an image source module configured to send the image data to the processor. The image source module may include one or more of a receiver, transceiver, and transmitter. The apparatus may further include an input device configured to receive input data and to communicate the input data to the processor.

In an implementation, a method to halftone video data may include receiving video data having a plurality of frames, each of the plurality of frames having a plurality of pixels. For each of the plurality of pixels in each of the plurality of frames, the method may determine if a respective pixel is associated with a substantially stationary and uniform region in a respective frame. If the respective pixel is not associated with a substantially stationary and uniform region in the respective frame, then the maethod may perform error diffusion on the respective pixel to generate an output pixel. Otherwise, the method may perform error diffusion on the respective pixel to generate an error-diffusion-based halftone value, and may perform mask-based dithering on the respective pixel to generate a mask-based dithering halftone value. The method may select one of the error diffusion-based halftone value and the mask-based dithering halftone value that is closer to a halftone value of a corresponding output pixel in a comparison frame, and generate the output pixel using the selected halftone value.

In an implementation, the comparison frame may be a frame immediately preceding a respective frame containing the respective pixel.

In another implementation, determining if the respective pixel is associated with a substantially stationary and uniform region in the respective frame may include: applying a high pass filter to image data within a local region containing the respective pixel; computing an average pixel value of pixels within the local region; and comparing the average pixel value computed with a corresponding average pixel value in the comparison frame. The local region may include a seven-by-seven pixel block and the respective pixel may be substantially centered in the pixel block.

Details of one or more implementations of the subject matter described in this specification are set forth in the accompanying drawings and the description below. Although the examples provided in this summary are primarily described in terms of MEMS-based displays, the concepts provided herein apply to other types of displays, such as organic light-emitting diode (“OLED”) displays and field emission displays. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 IMOD display.

FIG. 3 shows an example of a diagram illustrating movable reflective layer position versus applied voltage for the IMOD of FIG. 1.

FIG. 4 shows an example of a table illustrating various states of an IMOD when various common and segment voltages are applied.

FIG. 5A shows an example of a diagram illustrating a frame of display data in the 3×3 IMOD display of FIG. 2.

FIG. 5B shows an example of a timing diagram for common and segment signals that may be used to write the frame of display data illustrated in FIG. 5A.

FIG. 6A shows an example of a partial cross-section of the IMOD display of FIG. 1.

FIGS. 6B-6E show examples of cross-sections of varying implementations of IMODs.

FIG. 7 shows an example of a flow diagram illustrating a manufacturing process for an IMOD.

FIGS. 8A-8E show examples of cross-sectional schematic illustrations of various stages in a method of making an IMOD.

FIG. 9 shows an example of a block diagram of an apparatus including an electronic display and a display control module.

FIG. 10 shows an example of a block diagram of an apparatus for rendering an image on an electronic display.

FIG. 11 is an example of a data flow diagram illustrating one implementation of a mask-based dithering halftoning technique.

FIG. 12 shows an example of a halftone image generated by reducing a 24 bpp image to a 6 bpp image using mask-based dithering.

FIG. 13 shows an example of how temporal flicker may be produced by an error diffusion halftoning technique.

FIG. 14 is an example of a conceptual data flow diagram of one implementation of a hybrid video halftoning method.

FIG. 15 shows an example of an error clipping scheme in accordance with an implementation.

FIGS. 16A-B show an example of a method for halftoning video data in accordance with an implementation.

FIGS. 17A-B show an example comparison between performance of the disclosed halftoning technique and conventional error diffusion techniques.

FIGS. 18A and 18B show examples of system block diagrams illustrating a display device that includes a plurality of IMODs.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Described herein below are new techniques for halftoning video images. Input frames of video images may be received, where each input frame includes a number of input pixels. For each input frame, an output frame including a number of halftoned output pixels may be generated. Some of the halftoned output pixels may be generated using an error diffusion halftoning technique; others of the halftoned output pixels may be generated using a mask-based dithering halftoning technique. Selection of the halftoning technique may be performed on a pixel-by-pixel basis, and, advantageously, accounts for both spatial and temporal correlations. For example, the error diffusion technique may be advantageously selected for an input pixel when one or both of a temporal and spatial change rate exceeds a respective threshold. When neither threshold is exceeded, a selection between the mask-based dithering technique and the error diffusion technique may be made by (i) comparing a respective halftone value computed by each technique with a comparison halftone value of a corresponding output pixel in a comparison frame; and (ii) selecting the technique that results in a halftone value closer to the comparison halftone value. The comparison frame may be a frame preceding, or immediately preceding, the input frame.

Particular implementations of the subject matter described in this disclosure can be implemented to realize one or more of the following potential advantages. The presently disclosed video halftoning techniques substantially suppress objectionable visual artifacts introduced by known halftoning methods without substantially adding to the computational or memory demands of the electronic devices on which the techniques are implemented. In particular, temporal flicker that normally results from applying error diffusion techniques to flat field image elements or regions are substantially eliminated. As a result, the disclosed techniques improve the visual appearance of halftoned video images with respect to video images halftoned with traditional methods. Moreover, demands on computational resources, such as, particularly, frame buffer resources are reduced. Some implementations of the hybrid video halftoning techniques disclosed herein are particularly useful in reducing artifacts in images rendered by a low bit-depth device, such as low bit-depth display devices. Further, an increase in frame update rate may be achieved by the disclosed techniques, such as, in some implementations, when an image region is stationary, updating of pixels in that image region may be avoided, with a consequential reduction in frame updating time.

Although much of the description herein pertains to IMOD displays, the disclosed techniques could be used to advantage in other types of displays such as a plasma display, an electroluminescent (EL) display, an organic light-emitting diode (OLED) display, a super-twisted nematic liquid crystal display (STN LCD), or a thin film transistor liquid crystal display (TFT-LCD). Moreover, while the IMOD displays described herein generally include red, blue and green pixels, many implementations described herein could be used in reflective displays having other colors of pixels, such as having violet, yellow-orange and yellow-green pixels. Moreover, many implementations described herein could be used in reflective displays having more colors of pixels, such as having pixels corresponding to 4, 5, or more colors. Some such implementations may include pixels corresponding to red, blue, green and yellow. Alternative implementations may include pixels corresponding to at least red, blue, green, yellow and cyan.

An example of a suitable device, to which the described implementations may apply, is a reflective EMS or MEMS-based display device. Reflective display devices can incorporate IMODs to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the IMOD. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

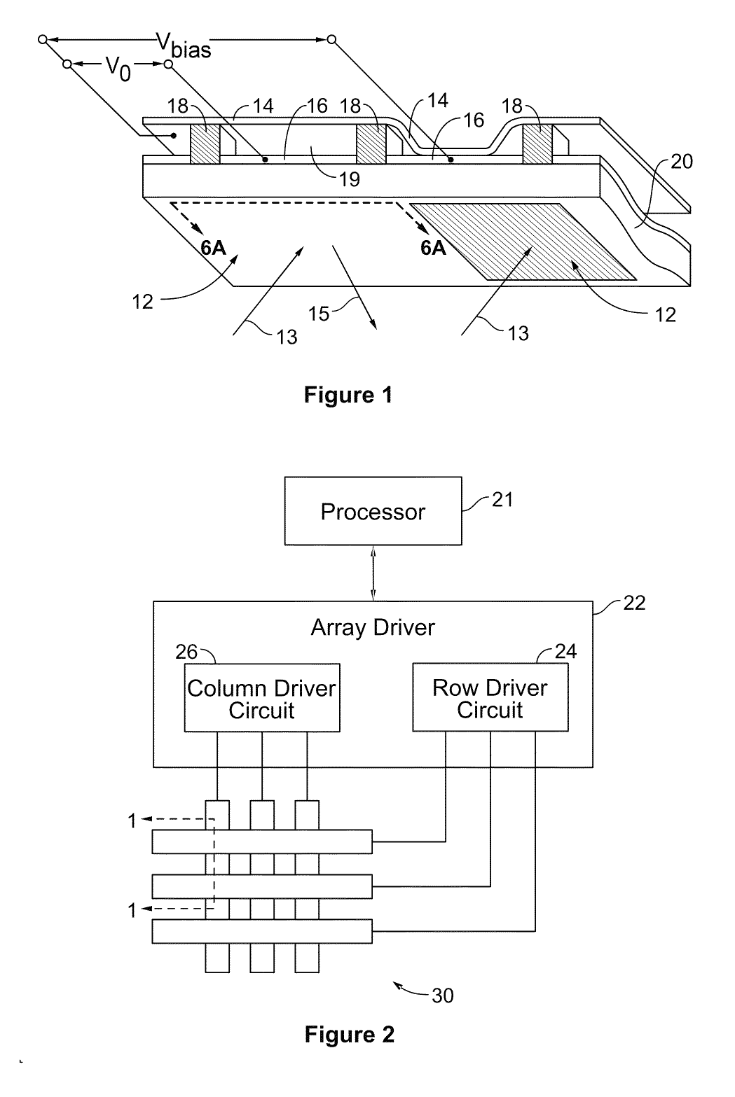

FIG. 1 shows an example of an isometric view depicting two adjacent pixels in a series of pixels of an IMOD display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent IMODs 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

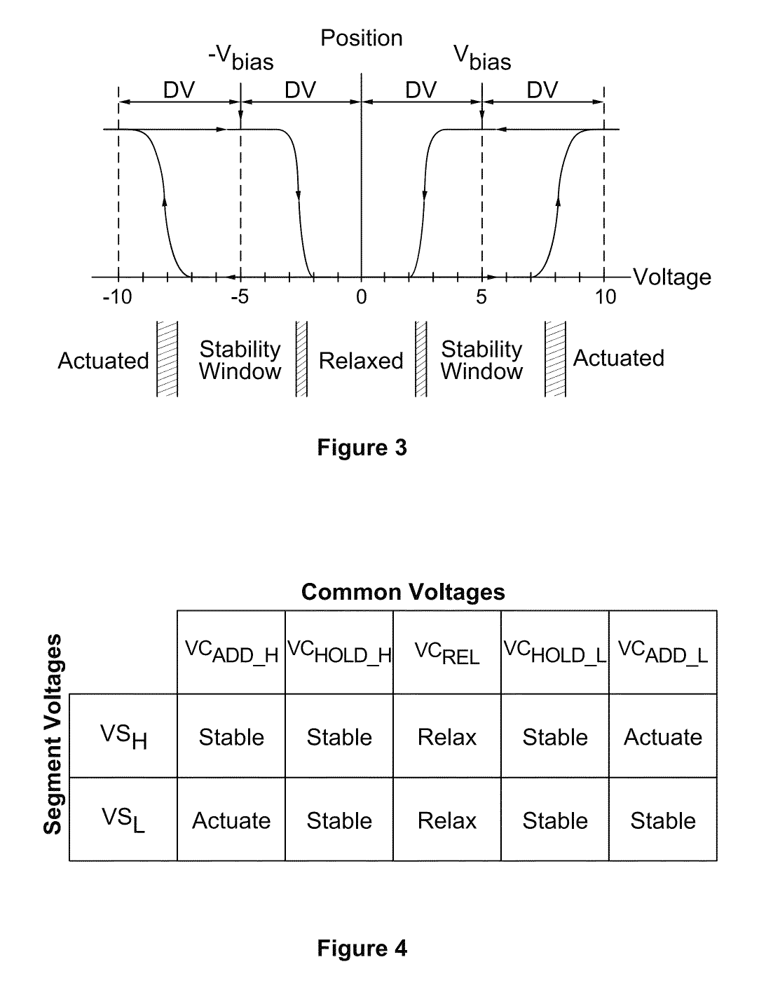

FIG. 2 shows an example of a system block diagram illustrating an electronic device incorporating a 3×3 IMOD display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

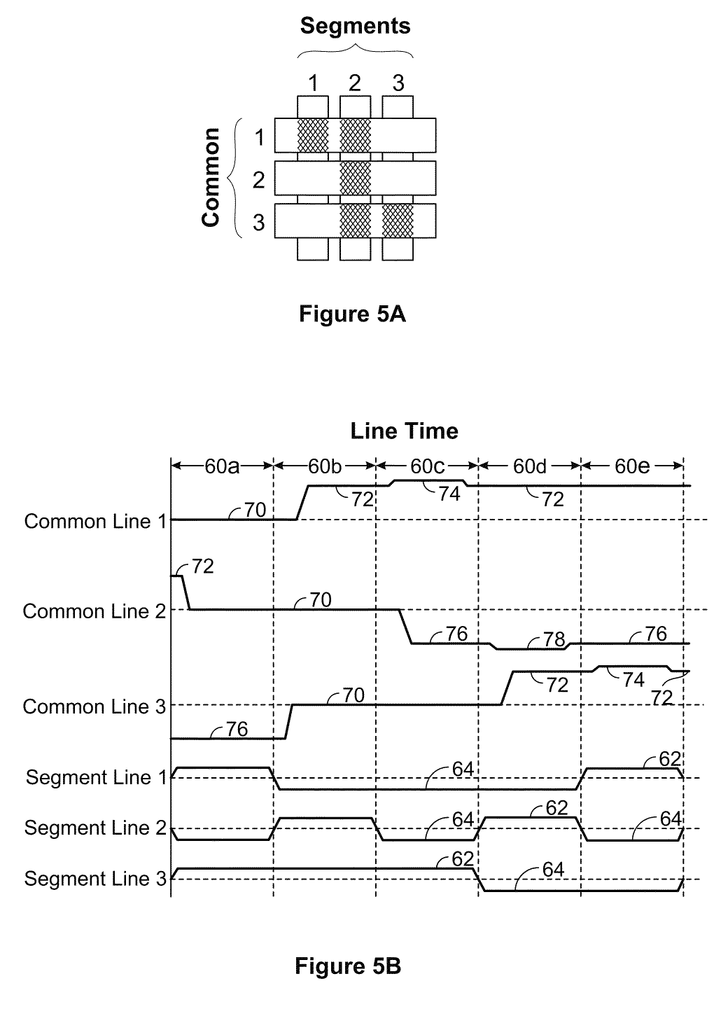

FIG. 3 shows an example of a diagram illustrating movable reflective layer position versus applied voltage for the IMOD of FIG. 1. For MEMS IMODs, the row/column (i.e., common/segment) write procedure may take advantage of a hysteresis property of these devices as illustrated in FIG. 3. An IMOD may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts; however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

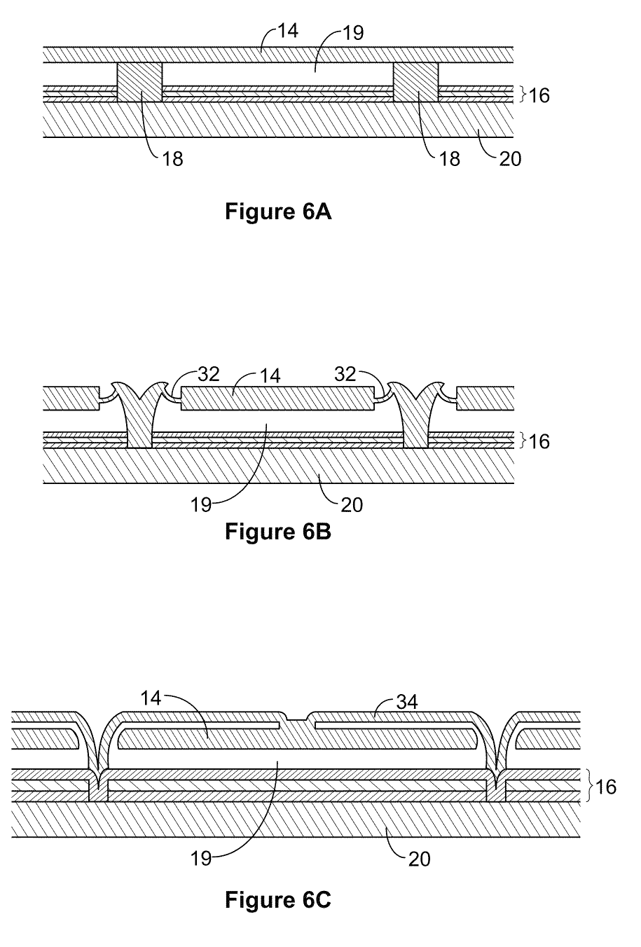

The combination of segment and common signals applied across each pixel (that is, the potential difference across each pixel) determines the resulting state of each pixel. FIG. 4 shows an example of a table illustrating various states of an IMOD when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

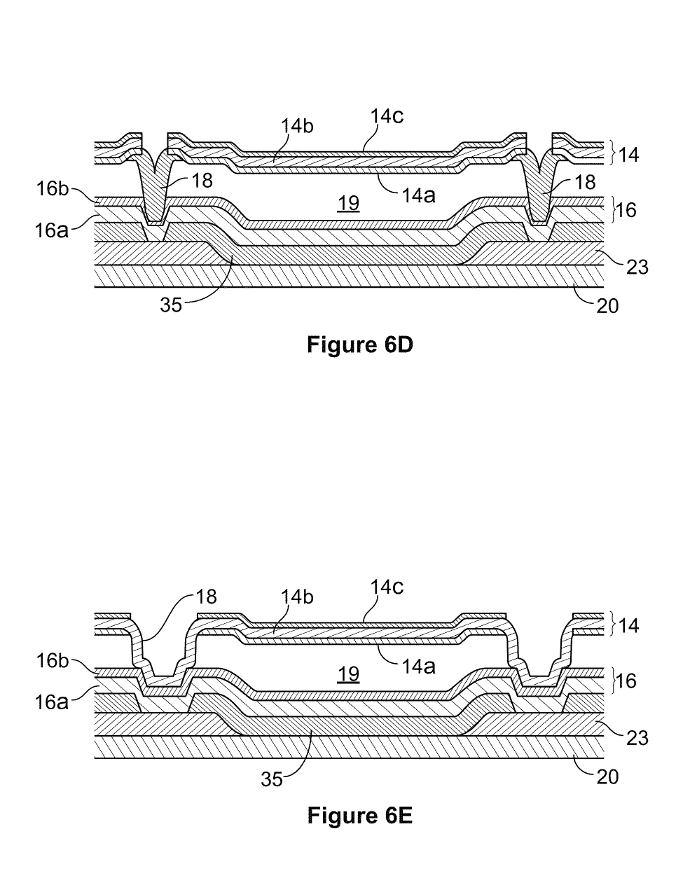

As illustrated in FIG. 4 (as well as in the timing diagram shown in FIG. 5B), when a release voltage VC_{REL} is applied along a common line, all IMOD elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the IMOD will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 IMOD display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the IMODs, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

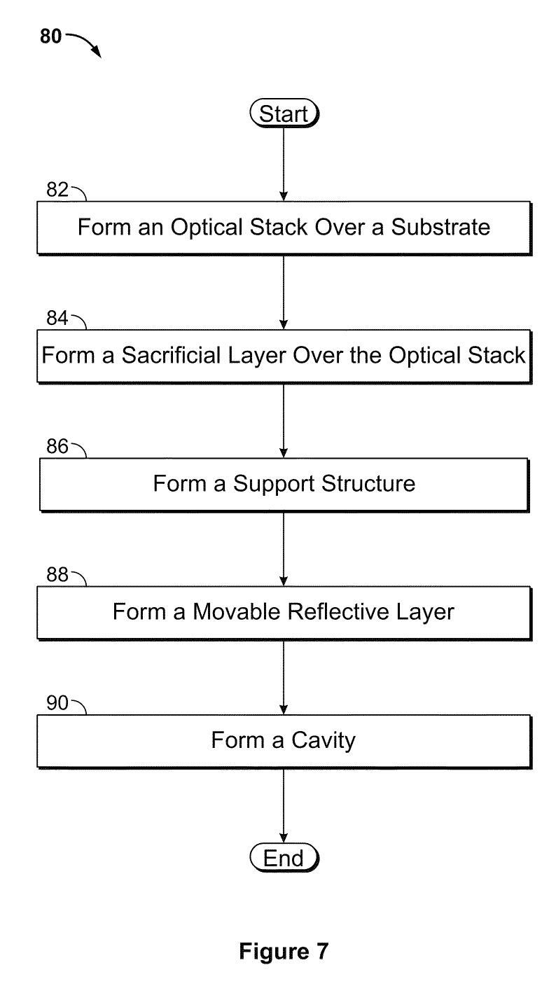

The details of the structure of IMODs that operate in accordance with the principles set forth above may vary widely. For example, FIGS. 6B-6E show examples of cross-sections of varying implementations of IMODs, including the movable reflective layer 14 and its supporting structures. FIG. 6A shows an example of a partial cross-section of the IMOD display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the IMOD is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as patterning.

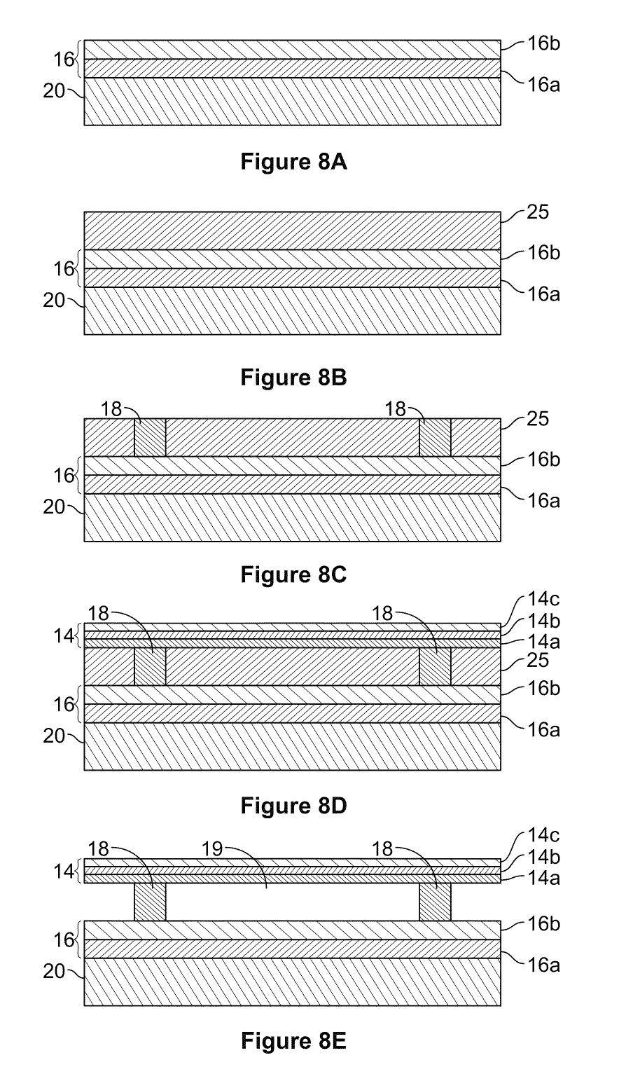

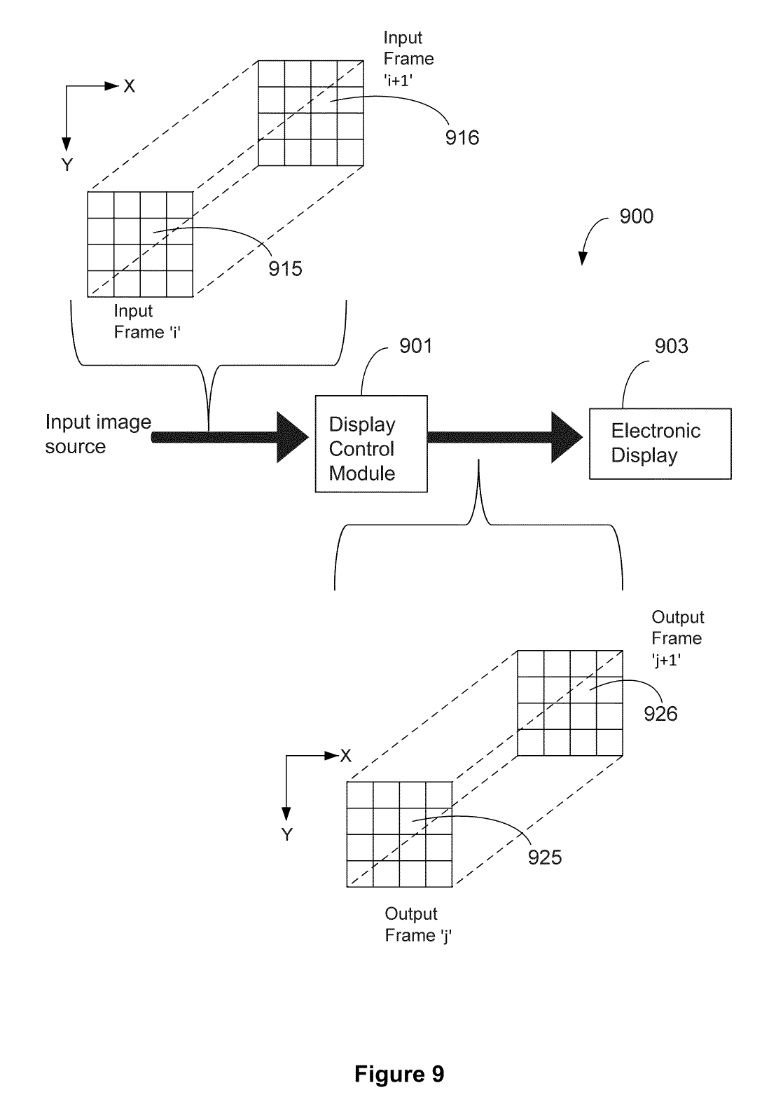

FIG. 7 shows an example of a flow diagram illustrating a manufacturing process 80 for an IMOD, and FIGS. 8A-8E show examples of cross-sectional schematic illustrations of corresponding stages of such a manufacturing process 80. In some implementations, the manufacturing process 80 can be implemented to manufacture an electromechanical systems device such as IMODs of the general type illustrated in FIGS. 1 and 6. The manufacture of an electromechanical systems device also can include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display. It is noted that FIGS. 8A8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting IMODs 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (such as a polymer or an inorganic material such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (such as aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated IMOD formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as cavity 19 illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

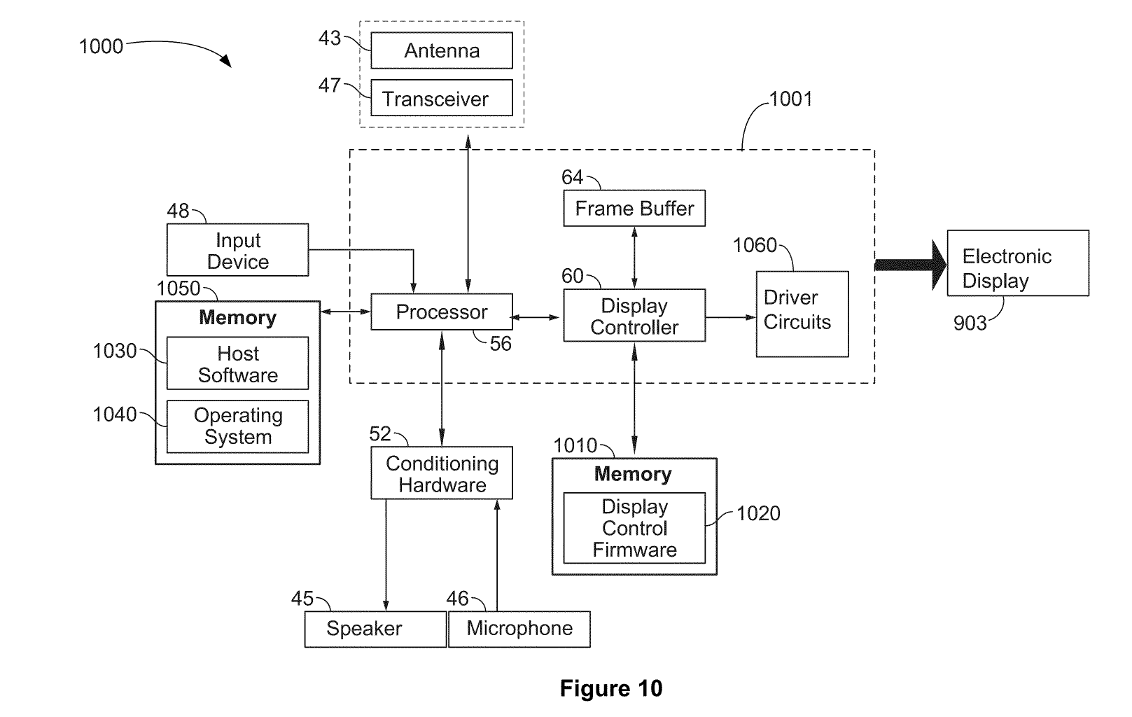

FIG. 9 shows an example of a block diagram of an apparatus including an electronic display and a display control module. In the illustrated implementation, an apparatus 900 includes electronic display 903 and a display control module 901. Display control module 901 may be configured to receive input frames of video data from an input image source. The input image source may include another component of the apparatus, such as, for example a memory or input device of the apparatus. In addition, or alternatively, the input image source may include those external to the apparatus, for example, a broadcast or cellular network, or the Internet.

Display control module 901 may be configured to render, on electronic display 903, an output frame of video data, such that electronic display 903 is caused to display a halftoned image corresponding to the input frame of video data. More particularly, display control module 901 may receive a plurality of input frames, on a frame by frame basis, for example, where each input frame includes a set of input pixels. Display control module 901 may be configured to generate, for each input frame, an output frame of video data, the output frame of video data including halftoned output pixels generated using a halftoning technique to be described in more detail herein below. As a result, an input video stream of sequential frames of continuous tone pixels may be converted to an output video stream of sequential frames of halftoned pixels.

Each pixel in a frame may be referred to by its spatial (x, y) coordinates within the frame, and by its temporal coordinates, which may be defined by frame number. For example, referring still to FIG. 9, pixel 915 in input frame ‘i’ may be identified as (3, 2, i). Pixel 925 in output frame ‘j’, located at the same (x, y) coordinate, may be said to correspond to pixel 915, and be identified as (3, 2, j). Similarly, pixel 926 in output frame ‘j+1’ may be identified as (3, 2, j+1) and be said to correspond to pixel 916 (3, 2, i+1).

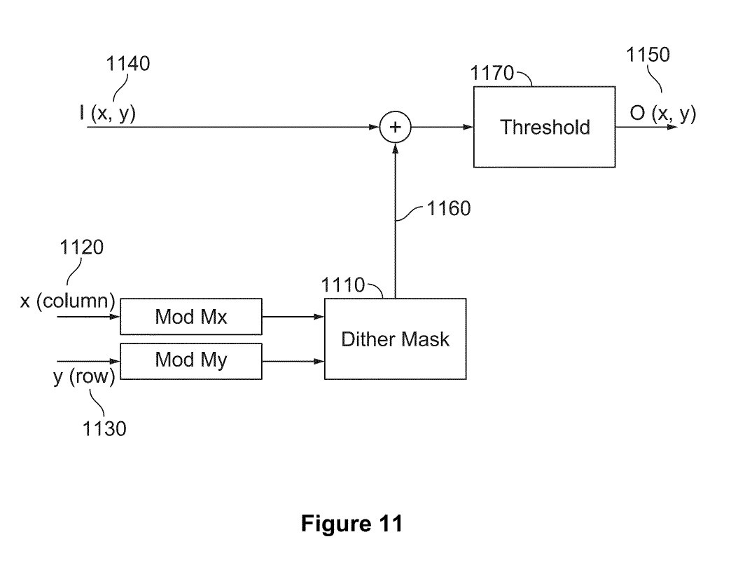

FIG. 10 shows an example of a block diagram of an apparatus for rendering an image on an electronic display. Apparatus 1000 includes electronic display 903 and display control module 1001. As illustrated, display control module 1001 includes processor 56, frame buffer 64, display controller 60 and driver circuits 1060. Display control module 1001, accordingly, is a particular implementation of display control module 901 illustrated in FIG. 9. Processor 56 may be in communication with a memory 1050. The memory 1050 may include host software 1030 and operating system 1040. Processor 56 may also be in communication with display controller 60. Display controller 60 may be in communication with a frame buffer 64 and a memory 1010. Memory 1010 may include display control firmware 1020.

In some implementations, instructions within operating system 1040 may manage the resources of apparatus 1000 to accomplish particular functions of apparatus 1000. For example, operating system 1040 may manage resources such as speaker 45 and microphone 46, as well as antenna 43 and transceiver 47. Operating system 1040 may also include display device drivers that manage electronic display 903, such as a display controlled by display controller 60. A display device driver within operating system 1040 may include instructions that render an image on an electronic display.

For example, instructions within operating system 1040 may render an image on electronic display 903. Operating system 1040 may further include instructions that configure the processor 56 to receive input frames of video data, each input frame including a set of pixels.

Operating system 1040 may further include instructions that configure processor 56 to compute a spatial change rate metric (CRM) and a temporal CRM for each input pixel and to generate corresponding halftoned output pixels. As described in more detail herein below, generating the corresponding halftoned output pixels may, advantageously, be performed using techniques selected as appropriate in light of the computed temporal and spatial CRM. Therefore, instructions within operating system 1040 represent one way for selecting and applying a halftoning technique.

In other implementations, the functions described above as included in operating system 1040 may instead be included in host software 1030. Alternatively, these functions may instead be implemented by instructions included in display control firmware 1020. In still other implementations, these functions may be implemented in special purpose circuits. It will be appreciated that other implementations that may vary from the block diagram of FIG. 10 are within the contemplation of the present disclosure.

One aspect of the present disclosure relates to adaptively selecting, on a pixel-by-pixel basis, between a mask-based dithering halftoning technique and an error diffusion halftoning technique. Accordingly, a better understanding of the present disclosure may result from summarizing certain characteristics of each technique.

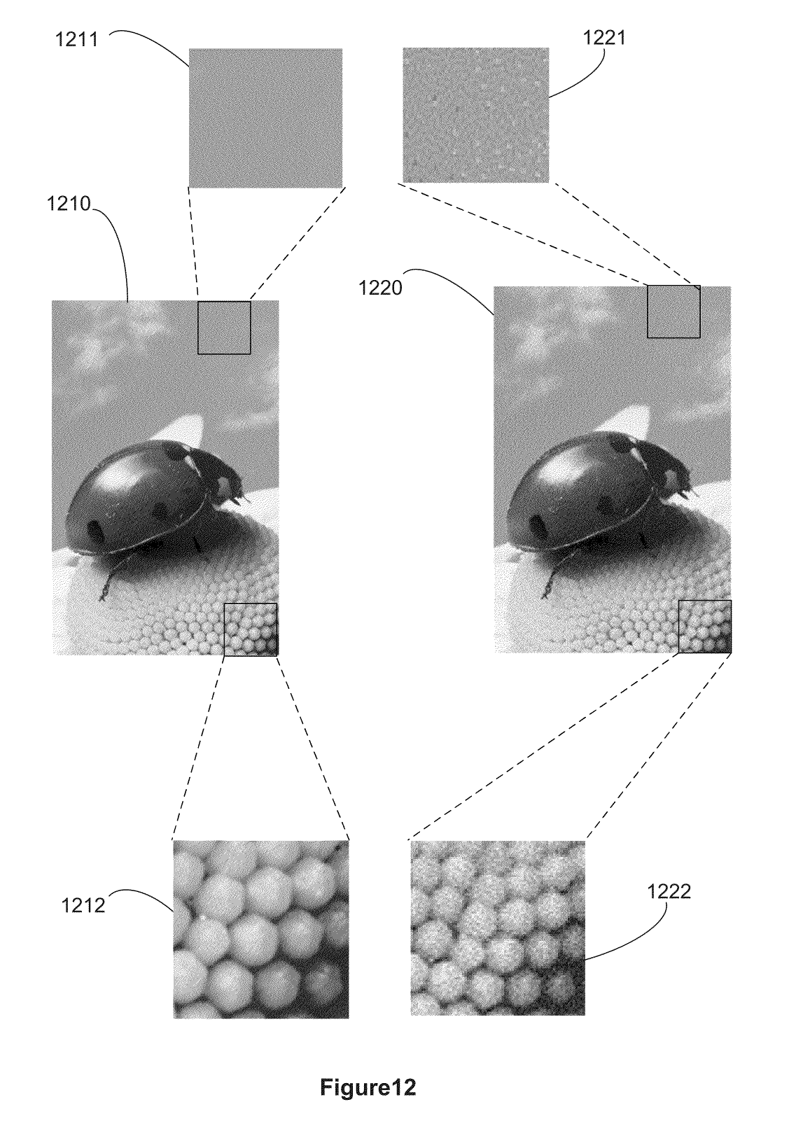

FIG. 11 is an example of a data flow diagram illustrating one implementation of a mask-based dithering halftoning technique. Mask-based dithering may be implemented as a low complexity method. A dither value may be determined by modularly addressing a dither mask 1110 with row 1130 and column 1120 addresses of the image pixels. The dither value 1160 is then added to input value 1140 of input pixel I(x,y). The sum of the dither value 1160 and input value 1140 may be compared with a fixed threshold 1170 to produce output value 1150 of output pixel O(x,y). For example, if the sum of the dither value 1160 and input value 1140 exceeds fixed threshold 1170, pixel value 1140 may be assigned a value of ‘1.’ On the other hand, if the sum of the dither value 1160 and input value 1140 does not exceed fixed threshold 1170, pixel value 1140 may be assigned a value of ‘0’.

Mask-based dithering halftoning methods are pixel-parallel, fast, and simple. However, halftone images from simple mask-based dithering have objectionable characteristics, such as, for example, pattern visibility, noisy appearance (especially in mid-tone areas), and poor reproduction of highly textured image details.

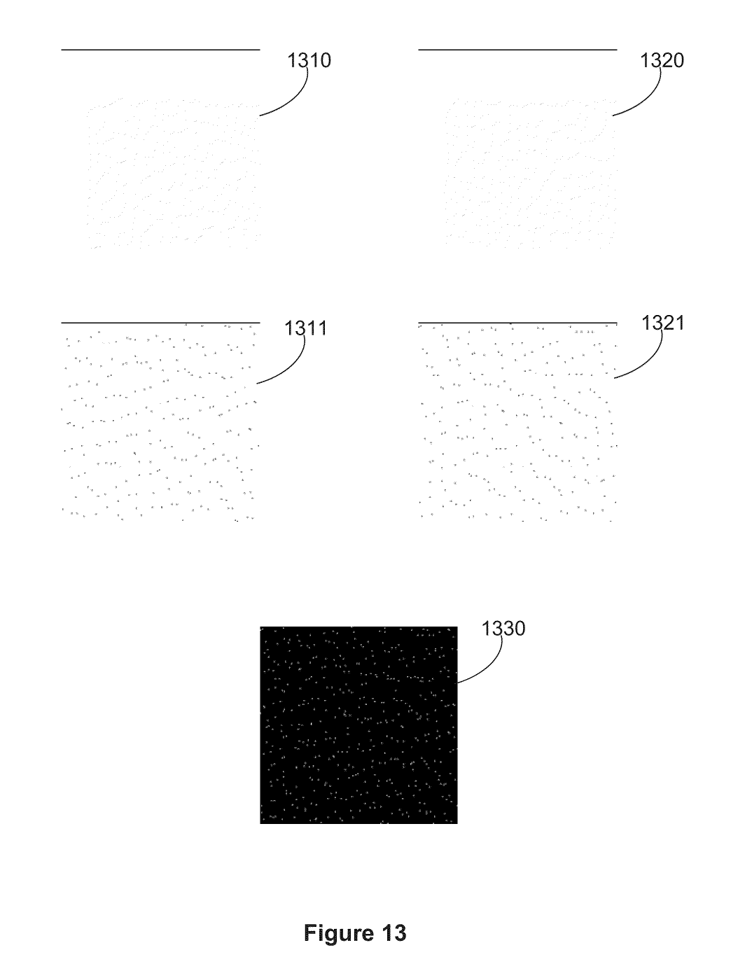

FIG. 12 shows an example of a halftone image generated by reducing a 24 bpp image to a 6 bpp image using mask-based dithering. Compared to original 24 bpp image 1210, halftoned image 1220 exhibits visibly apparent objectionable artifacts, and loss of detail, particularly in highly textured regions, as may be observed, for example by comparing detail 1212 to detail 1222. Relatively untextured (or “flat field”) regions, however, experience less degradation in image quality, as may be observed, for example, by comparing detail 1211 to detail 1221.

Error diffusion halftoning techniques based, for example, on Floyd Steinberg error diffusion (FSED) are known to provide better quality halftones than mask-based dithering, particularly for highly textured images. However, when the video image data relates to a static flat field image element, applying FSED-based methods can produce worm-like directional artifacts and/or generate temporal flickering or “boiling.” Boiling occurs when a stationary object in a video sequence is rendered with different halftone patterns in the corresponding halftone sequence. Halftone images generated by conventional Floyd-Steinberg error diffusion are particularly susceptible to boiling.

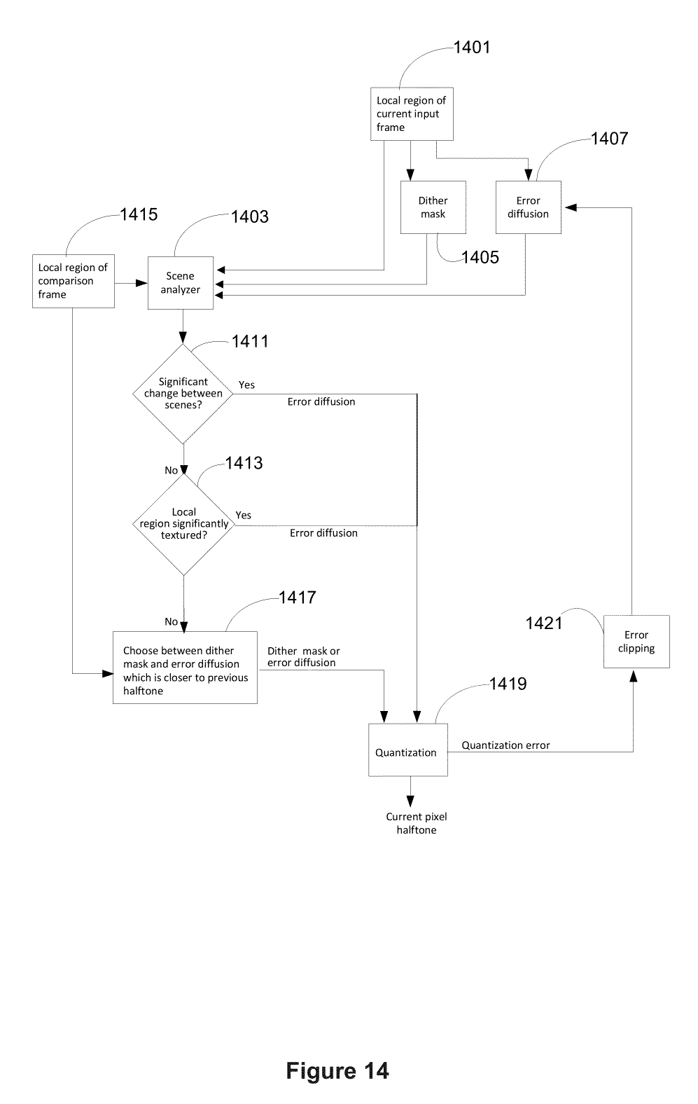

FIG. 13 shows an example of how temporal flicker may be produced by an error diffusion halftoning technique. Image 1310 and 1320, while giving the visual impression of being identical, are actually different input images to the error diffusion technique, which each resulted from adding a very small amount of uniform random noise to a constant tone image. Images 1311 and 1321 are halftoned images of, respectively, image 1310 and 1320. Image 1330 illustrates the difference between image 1311 and 1321. This difference is what human visual system can perceive as boiling, an objectionable visual artifact, at least where an image desired to be presented is flat field and stationary. On the other hand, where the image desired to be presented is highly textured, or changing from frame-to-frame, boiling is rarely a visible artifact.

According to various implementations, a hybrid video image halftoning technique may adaptively select, on a pixel-by-pixel basis, between an error diffusion halftoning technique and a mask-based dithering halftoning technique.

In one implementation, a temporal change rate metric (CRM) and a spatial CRM may be computed for each pixel. The temporal CRM may quantify a comparison of image data for a current frame of an image element at or near the pixel, to corresponding image data from a comparison frame. The comparison frame may be, for example, a preceding frame or an immediately preceding frame. The temporal CRM of each input pixel may be computed by comparing a halftone value of the input pixel to a halftone value of a corresponding output pixel of the comparison frame. A higher value for a temporal CRM, for example, may indicate a rapid change in image data with respect to time, meaning, for example, that an image element is moving from frame to frame. A lower value for a temporal CRM, on the other hand, may indicate that the image element is relatively static with respect to time.

The spatial CRM may quantify a comparison of image data to be rendered by the pixel to image data to be rendered by adjacent or nearby pixels. A higher value for a spatial CRM, for example, may indicate that the pixel in the current frame represents part of a highly textured image element, or an edge of an image element. A lower value for a spatial CRM, on the other hand, may indicate that the pixel in the current frame represents part of an image element that is relatively flat field. The spatial CRM of each input pixel may be computed by comparing a data value for the input pixel to corresponding data values for neighboring input pixels. The neighboring input pixels and the input pixel may be located in a common local region of the input frame. The local region may be, for example, a 3×3 pixel block, a 5×5 pixel block, a 7×7 pixel block, etc., and the input pixel may be substantially centered in the local region.

For each pixel, a halftoning technique may be selected taking into account the computed spatial CRM and temporal CRM. Unless each of the spatial CRM and the temporal CRM is less than a respective threshold value, halftoning may be performed using an FSED halftoning technique. When both first CRM and second CRM are less than the respective threshold values, halftoning may be performed with either the error diffusion halftoning technique or a mask-based dithering technique. Advantageously, however, two halftone values may be determined, namely, a first halftone value produced by an error diffusion halftoning technique, and a second halftone value produced by a mask-based dithering technique. One of the two halftone values may be selected such that the selected value results in a lesser change from the halftone value of the pixel in the comparison frame.

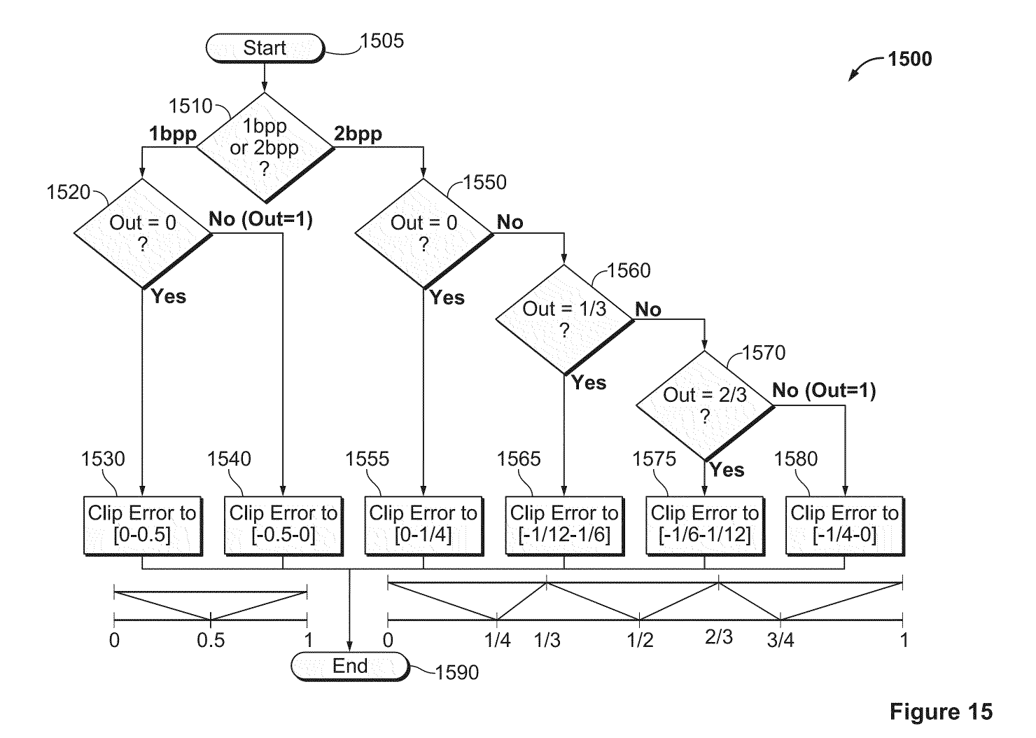

FIG. 14 is an example of a conceptual flow diagram of one implementation of a hybrid video halftoning technique. At block 1401, current input frame data may be received. Each input frame may include a number of input pixels encoded, for example at 24 bpp. Local regions of each input frame may be sequentially forwarded to scene analyzer block 1403, dither mask block 1405 and error diffusion block 1407. Each local region may be, for example, a 3×3 pixel block, a 5×5 pixel block, a 7×7 pixel block, etc.

Blocks 1405 and 1407 may operate substantially in parallel and, on a pixel-by-pixel basis, may each compute a halftone value for each pixel using, respectively, a mask-based dithering halftoning technique and an error diffusion halftoning technique.

Outputs of blocks 1405 and 1407 may be forwarded to scene analyzer block 1403. Scene analyzer block 1403 also receives from block 1415 halftone image data for corresponding local elements of a comparison frame. In some implementations, the comparison frame may be a preceding frame, such as an immediately preceding frame, for example. In an implementation, the halftone image data for the corresponding local elements of the comparison frame are stored in a frame buffer, for example frame buffer 64.

Scene analyzer block 1403 may compute, for each pixel, the spatial CRM and the temporal CRM as described above. Based on the computed temporal CRM, at decision block 1411, a determination may be made whether local image data is changing significantly, with respect to time, such that the temporal CRM exceeds a first threshold. When the temporal CRM exceeds the first threshold, the pixel, at quantization block 1419, may be halftoned by the error diffusion halftoning technique.

When the temporal CRM does not exceed the first threshold, a determination may be made, at decision block 1413, based on the computed spatial CRM, whether the current pixel belongs to a significantly textured local region, such that the spatial CRM exceeds a second threshold. When the spatial CRM exceeds the second threshold, the pixel, at quantization block 1419, may be halftoned by the error diffusion halftoning technique.

When the spatial CRM does not exceed the second threshold, at block 1417, a choice may be made between the mask-based dithering halftoning technique and the error diffusion halftoning technique. In one implementation, the selected technique is the technique that produces a halftone value closer to the halftone value of the corresponding output pixel in a comparison frame, for example, a preceding frame. At quantization block 1419, a halftoned output pixel is generated using the selected technique. A quantization error is also output from block 1419 and forwarded to error clipping block 1421, operation of which will be described herein below. An output of error clipping block 1421 is forwarded to error diffusion block 1407.

Advantageously, block 1421 clips quantization error into a particular, acceptable, error range. In a conventional error diffusion method, quantization error is inherently bounded. For example, in bi-level error diffusion where an output is either 0 (black) or 1 (white) and the threshold is about 0.5, the range of quantization error is about −0.5 to 0.5. This bound may never be exceeded because whenever the quantization error approaches this bound, error diffusion forces the error to move in the opposite direction (closer to the other threshold). However, in the proposed hybrid halftoning, in the absence of the present error clipping scheme, the quantization error is not necessarily bounded because mask-based dithering halftoning operates independently of quantization error in general. As such, error clipping block 1421 can be provided in some implementations to keep the quantization error bounded.

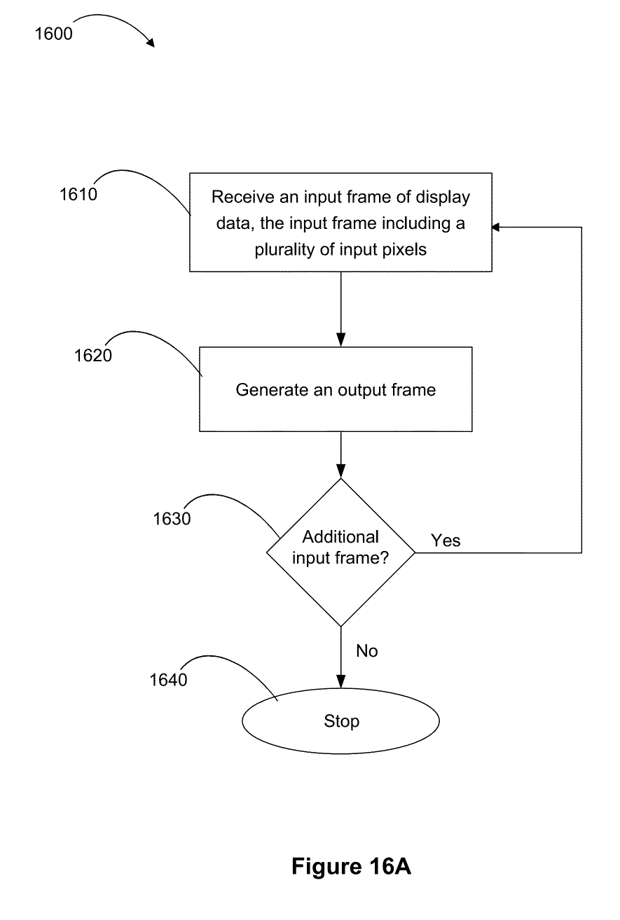

FIG. 15 shows an example of an error clipping scheme in accordance with an implementation. The error clipping scheme may support bi-level halftoning (1 bpp output) and multi-level halftoning (for example, 2 bpp output). In some implementations, error clipping process 1500 may be implemented by instructions contained in operating system 1030, host program 1040, or display controller firmware 1020 illustrated in FIG. 10. The error clipping scheme illustrated in FIG. 15 may be implemented in block 1421 of FIG. 14 in some implementations.

Process 1500 of FIG. 15 starts at start block 1505 and then moves to decision block 1510 where it may be determined whether the halftoning mode is one bit per pixel or two bits per pixel. If the halftoning mode is one bit per pixel data, process 1500 moves from decision block 1510 to decision block 1520, where the output bit may be compared to zero. If the output bit is not zero, process 1500 moves to processing block 1540 where the error is clipped. In the illustrated implementation, the error is clipped to between about −0.5 and 0.0, but other clip values may be used in different implementations. If the output bit is zero, process 1500 moves to processing block 1530, where the error is clipped. In the illustrated implementation, the error is clipped to between zero and 0.5, but other clip values may be used in different implementations.

If the halftoning mode is two bits per pixel, process 1500 moves from decision block 1510 to decision block 1550 where the output pixel is compared to zero. If the output pixel is zero, process 1500 moves from decision block 1550 to processing block 1555, where the error is clipped. In the illustrated implementation, the error is clipped to between 0.0 and 0.25, but other clip values may be used in different implementations. If the output bit is not zero, process 1500 moves from decision block 1550 to decision block 1560, where the output pixel is compared to ⅓ (0x01). If the output bits are set to ⅓, process 1500 moves from decision block 1560 to processing block 1565, where the error is clipped. In the illustrated implementation, the error is clipped to a value between − 1/12 and ⅙, but other clip values may be used in different implementations. If the output pixel does not equal ⅓, process 1500 moves from decision block 1560 to decision block 1570, where the output pixel is compared to a value of ⅔ (0x10). If the output pixel does equal ⅔, process 1500 moves from decision block 1570 to processing block 1575, where the error is clipped. In the illustrated implementation, the error is clipped to a value between −⅙ and 1/12, but other clip values may be used in different implementations. If the output pixel does not equal ⅔, process 1500 moves to processing block 1580 where the error is clipped. In the illustrated implementation, the error is clipped to a value between −¼ and 0, but other clip values may be used in different implementations. Process 1500 then moves to end state 1590. It will be appreciated that the error clipping method illustrated in FIG. 15 can be generalized for higher bit depths.

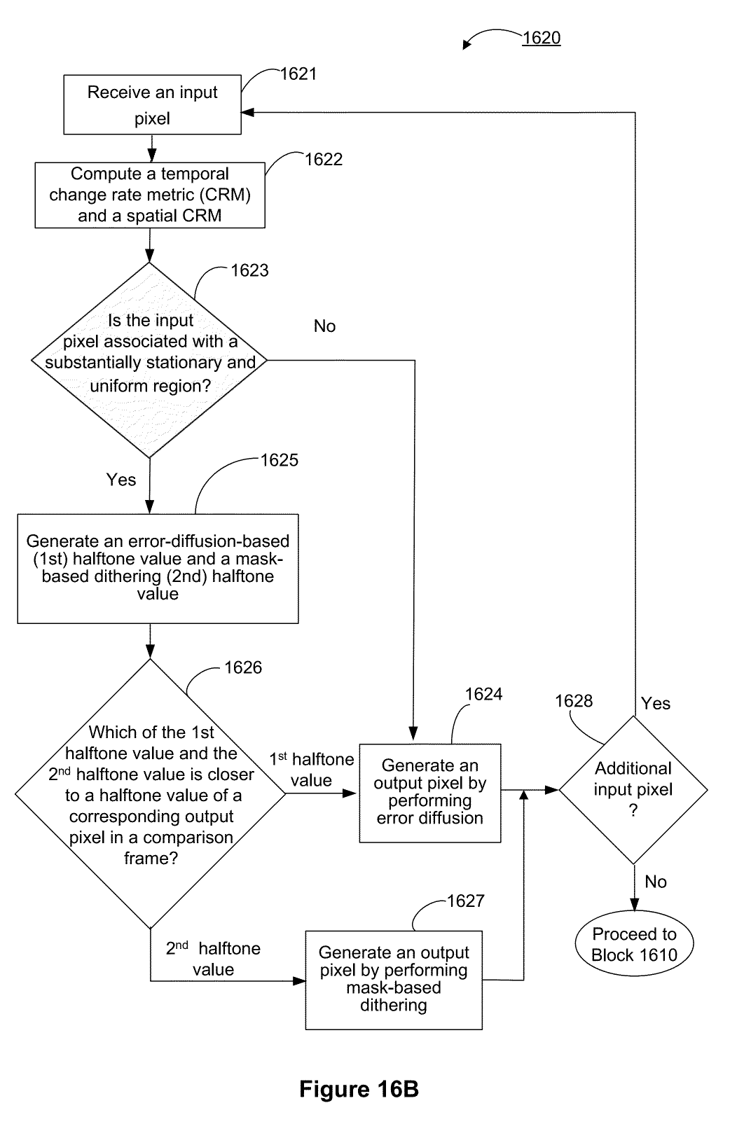

FIGS. 16A-B show an example of a method for halftoning video data in accordance with an implementation. Referring first to FIG. 16A, in an implementation, halftoning method 1600 may be performed by display control module 901 or 1001 as depicted, respectively, in FIG. 9 and FIG. 10.

The method may begin at block 1610 with receiving an input frame of video data, the input frame including a plurality of input pixels. The input frame may be received from another component of an apparatus including an electronic display, such as, for example a memory or input device of the apparatus. In addition, or alternatively, the source of the input frame may be external to the apparatus, for example, a broadcast or cellular network, or the Internet.

At block 1620, an output frame of video data may be generated. The output frame may include halftoned output pixels, generated in accordance with a method illustrated in FIG. 16B.

At block 1630, a determination may be made whether an additional input frame remains to be processed. If there is at least one additional input frame remaining to be processed, the process may return to block 1610. If there is no more input frame to be processed, the process may stop at block 1640.

Referring now to FIG. 16B, a more detailed illustration of process block 1620 will be described.

At block 1621 an input pixel may be received. The input pixel may be one of a number of pixels associated with a common input frame.

At block 1622, a temporal CRM and a spatial CRM may be computed. The temporal CRM may quantify a comparison of image data for a current frame of an image element at or near the pixel, to corresponding image data from a comparison frame. In an implementation, the temporal CRM may be determined by comparing a local average pixel value of the current input frame and a local average pixel value of a corresponding pixel in the comparison frame. The comparison frame may be a preceding frame, such as an immediately preceding frame, but this is not necessarily so. The temporal CRM of each input pixel may be computed by comparing a halftone value of the input pixel to a halftone value of a corresponding output pixel of the comparison frame. A higher value for a temporal CRM, for example, may indicate a rapid change in image data with respect to time, meaning, for example, that an image element is moving from frame to frame. A lower value for a temporal CRM, on the other hand, may indicate that the image element is relatively static with respect to time.

The spatial CRM may quantify a comparison of image data to be rendered by the pixel to image data to be rendered by adjacent or nearby pixels. A higher value for a spatial CRM, for example, may indicate that the pixel, in the current frame, represents part of a highly textured image element or an edge of an image element. A lower value for a spatial CRM, on the other hand, may indicate that the pixel, in the current frame, represents part of an image element that is relatively flat field. The spatial CRM of each input pixel may be computed by comparing a data value for the input pixel to corresponding data values for neighboring input pixels. In an implementation, the spatial CRM may be computed by applying a two dimensional high pass filter to the image data.

At block 1623, a determination may be made as to whether the input pixel is associated with a substantially stationary and uniform region in a respective frame. If neither of the temporal CRM and the spatial CRM exceeds a respective, separately determined, threshold, a determination may be made that the input pixel is associated with a substantially stationary and uniform region in a respective frame. If either the temporal CRM exceeds its respective threshold or the spatial CRM exceeds its respective threshold, the method may proceed to block 1624. On the other hand, if both the temporal CRM and the spatial CRM are less than or equal to their respective thresholds, a determination may be made that the input pixel is associated with a substantially stationary and uniform region in the respective frame, the method may proceed to block 1625.

At block 1625, an error-diffusion based halftone value and a mask-based dithering halftone value may be generated.

At block 1626, a determination may be made as to which of the first halftone value and the second halftone value is closer to a halftone value of a corresponding output pixel in a comparison frame. Based on the determination, one of the error diffusion-based halftone value and the mask-based dithering halftone value that is closer to the halftone value of the corresponding output pixel in the comparison frame may be selected. If the error diffusion-based halftone value is selected, the method may proceed to block 1624. On the other hand, if the mask-based dithering halftone value is selected, the method may proceed to block 1627.

At block 1624, a halftoned output pixel may be generated by performing error diffusion on the input pixel.

At block 1627, a halftoned output pixel may be generated an output pixel by performing mask-based dithering on the input pixel.

At block 1628, a determination may be made whether an additional input pixel remains to be processed. If yes, the process may return to block 1621. If no, the process may return to block 1630 in FIG. 16A.

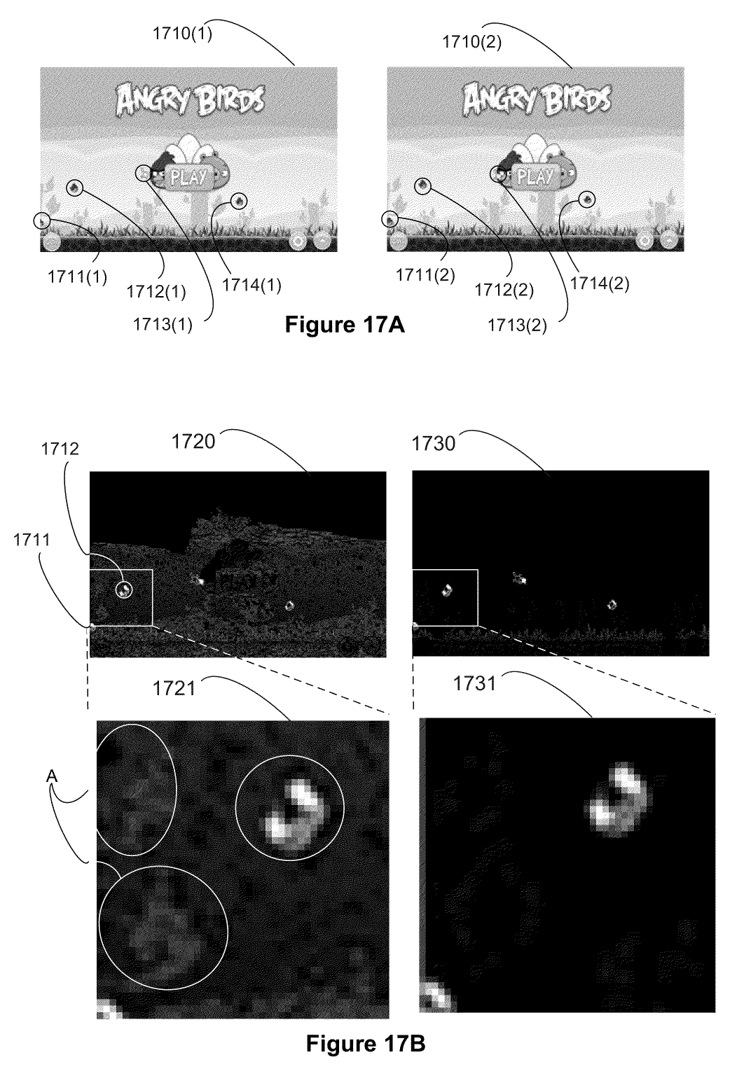

FIGS. 17A-B show an example comparison between performance of the disclosed halftoning technique and conventional error diffusion techniques. Referring first to FIG. 17A, frames 1710(1) and 1710(2) illustrate two sequential input frames of video data extracted from a video sequence. It will be appreciated that image elements 1711, 1712, 1713 and 1714 are in motion. Other than image data affected by the motion of image elements 1711, 1712, 1713 and 1714, the image data of frame 1710(1) is substantially identical to 1710(2).

Referring now to FIG. 17B, image 1720 shows the difference between halftone images of frame 1710(1) and 1710(2), where the halftoned images resulted from conventional error diffusion techniques. Significant differences in image data associated with the movement of image element of 1712(1) appear white, whereas unchanged data appear black. It may be observed, referring now to detail 1721 of image 1720, that, although the input data is actually unchanged from frame to frame outside the immediate vicinity of image element 1712(1), differences between the halftone images are manifested by gray pixelation particularly at highlighted regions A. These differences, in a sequence of halftoned frames, would produce objectionable temporal flickering or boiling. Image 1730 and detail 1731 thereof show the difference between halftone images of frame 1710(1) and 1710(2), where the halftoned images resulted from the presently disclosed halftoning techniques. It may be observed that regions of detail 1731 outside the immediate vicinity of moving image elements 1711 and 1712 are black, meaning that objectionable boiling has been substantially reduced or eliminated.

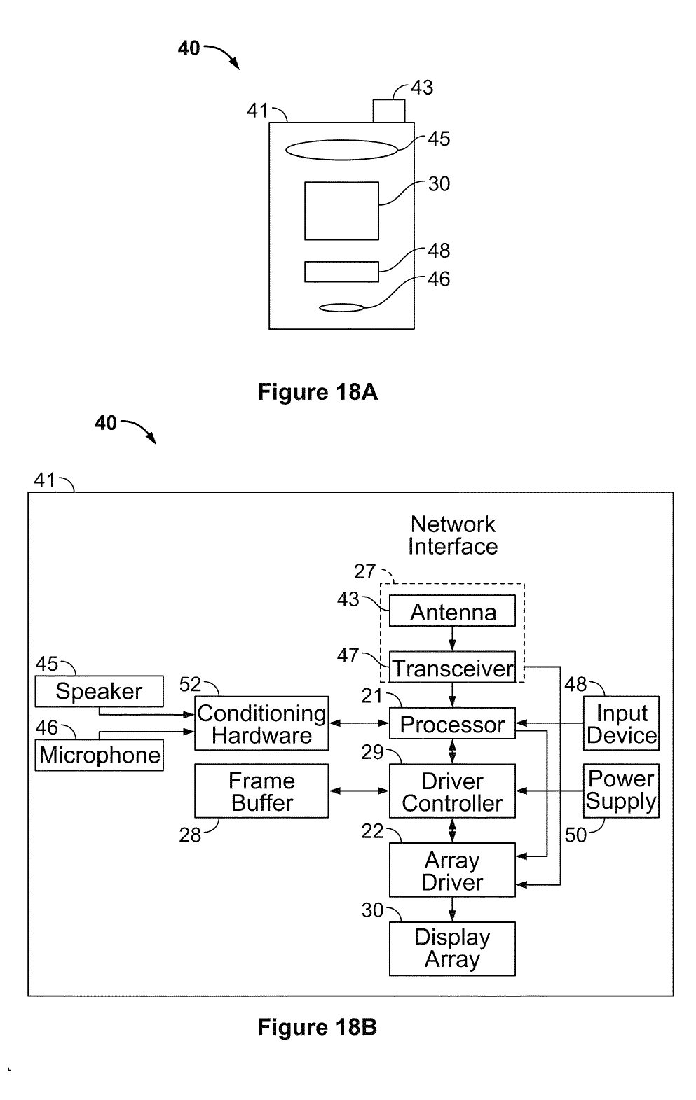

FIGS. 18A and 18B show examples of system block diagrams illustrating a display device 40 that includes a plurality of IMODs. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD display, as described herein.

The components of the display device 40 are schematically illustrated in FIG. 20B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
an electronic display; and
a display control module, the display control module configured to:
receive a plurality of input frames of video data, each input frame including a plurality of input pixels;
generate, for each input frame, an output frame of video data, the output frame including a first subset of halftoned output pixels and a second subset of halftoned output pixels, by:
computing a temporal change rate metric (CRM) and a spatial CRM for each input pixel;
generating the first subset of halftoned output pixels by generating, using an error diffusion technique, a corresponding halftoned output pixel for each input pixel in a first subset of the input pixels, the first subset including only input pixels for which one or both of the temporal CRM and the spatial CRM exceeds a respective threshold; and
generating the second subset of halftoned output pixels by generating, using a selected halftoning technique, a corresponding halftoned output pixel for each input pixel in a second subset of the input pixels, the second subset including only input pixels for which each of the temporal CRM and the spatial CRM is less than or equal to the respective threshold;
wherein, the display control module is configured to determine the selected halftoning technique by:
(i) computing a first halftone value using the error diffusion technique,
(ii) computing a second halftone value using a mask-based dithering technique,
(iii) comparing each of the first halftone value and the second halftone value to a comparison halftone value of a corresponding output pixel in a comparison frame,
(iv) when the comparing indicates the second halftone value is closer to the comparison halftone value than the first halftone value, selecting, for first individual ones of the second subset of pixels, the mask-based dithering technique; and
(v) when the comparing indicates the second halftone value is not closer to the comparison halftone value than the first halftone value, selecting, for second individual ones of the second subset of pixels, the error diffusion technique; and
render each output frame on the electronic display to form a displayed halftone video image.

2. The apparatus of claim 1, wherein computing the temporal CRM of each input pixel includes comparing a halftone value of the input pixel to a halftone value of a corresponding output pixel of a comparison frame.

3. The apparatus of claim 2, wherein the comparison frame precedes the input frame.

4. The apparatus of claim 1, wherein computing the spatial CRM of each input pixel includes comparing a data value for the input pixel to a corresponding data value for neighboring input pixels, the neighboring input pixels and the input pixel being located in a common local region.

5. The apparatus of claim 4, wherein one or both of the first data value and the corresponding data value are halftone values.

6. The apparatus of claim 4, wherein the common local region includes one of a three by three pixel block, a five by five pixel block, or a seven by seven pixel block.

7. The apparatus of claim 1, wherein:
the mask-based dithering halftoning technique includes dithering the input pixel with a mask;
the error diffusion technique includes quantizing the input pixel and diffusing a first quantization error with an error diffusion filter; and
the first quantization error includes a second quantization error resulting from the mask-based dithering halftoning technique.

8. The apparatus of claim 7, wherein the second quantization error is computed by clipping a quantization error resulting from the mask-based dithering halftoning technique.

9. The apparatus of claim 1, further comprising:
a processor that is configured to communicate with the electronic display, the processor being configured to process image data; and
a memory device that is configured to communicate with the processor.

10. The apparatus of claim 9, further comprising:
a driver circuit configured to send at least one signal to the electronic display; and
a controller configured to send at least a portion of the image data to the driver circuit.

11. The apparatus of claim 9, further including an image source module configured to send the image data to the processor, wherein the image source module includes one or more of a receiver, transceiver, and transmitter.

12. The apparatus of claim 9, further comprising:
an input device configured to receive input data and to communicate the input data to the processor.

13. A method to halftone video data, comprising:
receiving video data having a plurality of frames, each of the plurality of frames having a plurality of pixels;
for each of the plurality of pixels in each of the plurality of frames,
determining if a respective pixel is associated with a substantially stationary and uniform region in a respective frame;
if the respective pixel is not associated with a substantially stationary and uniform region in the respective frame, then
performing error diffusion on the respective pixel to generate an output pixel;
otherwise,
performing error diffusion on the respective pixel to generate an error-diffusion-based halftone value,
performing mask-based dithering on the respective pixel to generate a mask-based dithering halftone value,
selecting one of the error diffusion-based halftone value and the mask-based dithering halftone value that is closer to a halftone value of a corresponding output pixel in a comparison frame, and
generating the output pixel using the selected halftone value.

14. The method of claim 13, wherein the comparison frame is a frame immediately preceding a respective frame containing the respective pixel.

15. The method of claim 13, wherein determining if the respective pixel is associated with a substantially stationary and uniform region in the respective frame includes:
applying a high pass filter to image data within a local region containing the respective pixel;
computing an average pixel value of pixels within the local region; and
comparing the average pixel value computed with a corresponding average pixel value in the comparison frame.

16. The method of claim 15, wherein the local region includes a seven-by-seven pixel block and the respective pixel is substantially centered in the pixel block.

17. An apparatus comprising:
an electronic display;
a display control module configured to receive a plurality of input frames of video data, each input frame including plurality of input pixels; and
means for:
generating, for each input frame, an output frame of video data, the output frame including a first subset of halftoned output pixels and a second subset of halftoned output pixels, by:
computing a temporal change rate metric (CRM) and a spatial CRM for each input pixel;
generating the first subset of halftoned output pixels by generating, using an error diffusion halftoning technique, a corresponding halftoned output pixel for each input pixel in a first subset of the input pixels, the first subset including only input pixels for which one or both of the temporal CRM or the spatial CRM exceeds a respective threshold; and
generating the second subset of halftoned output pixels by generating, using a selected halftoning technique, a corresponding halftoned output pixel for each input pixel in a second subset of the input pixels, the second subset including only input pixels for which each of the temporal CRM and the spatial CRM is less than or equal to the respective threshold;
wherein, the selected halftoning technique is determined by:
(i) computing a first halftone value using the error diffusion technique,
(ii) computing a second halftone value using a mask-based dithering technique,
(iii) comparing each of the first halftone value and the second halftone value to a comparison halftone value of a corresponding output pixel in a comparison frame, and
(iv) when the comparing indicates the second halftone value is closer to the comparison halftone value than the first halftone value, selecting, for first individual ones of the second subset of pixels, the mask-based dithering technique; and
(v) when the comparing indicates the second halftone value is not closer to the comparison halftone value than the first halftone value, selecting, for second individual ones of the second subset of pixels, the error diffusion technique.

18. The apparatus of claim 17, wherein computing the temporal CRM of each input pixel includes comparing a halftone value of the input pixel to a halftone value of a corresponding output pixel of a comparison frame.

19. The apparatus of claim 17, wherein computing the spatial CRM of each input pixel includes comparing a data value for the input pixel to a corresponding data value for neighboring input pixels, the neighboring input pixels and the input pixel being located in a common local region.

20. The apparatus of claim 17, wherein the display control module is configured to render the output frame on an electronic display

21. A computer-readable storage medium having stored thereon instructions which, when executed by a computing system, cause the computing system to perform operations, the operations comprising:
receiving a plurality of input frames of video data, each input frame including a plurality of input pixels; and
generating, for each input frame, an output frame of video data, the output frame including a first subset of halftoned output pixels and a second subset of halftoned output pixels, by:
computing a temporal change rate metric (CRM) and a spatial CRM for each input pixel;
generating the first subset of halftoned output pixels by generating, using an error diffusion halftoning technique, a corresponding halftoned output pixel for each input pixel in a first subset of the input pixels, the first subset including only input pixels for which one or both of the temporal CRM or the spatial CRM exceeds a respective threshold; and
generating the second subset of halftoned output pixels by generating, using a selected halftoning technique, a corresponding halftoned output pixel for each input pixel in a second subset of the input pixels, the second subset including only input pixels for which each of the temporal CRM and the spatial CRM is less than or equal to the respective threshold;
wherein, the instructions, when executed by a computing system, cause the computing system to determine the selected halftoning technique by:
(i) computing a first halftone value using the error diffusion technique,
(ii) computing a second halftone value using a mask-based dithering technique,
(iii) comparing each of the first halftone value and the second halftone value to a comparison halftone value of a corresponding output pixel in a comparison frame, and
(iv) when the comparing indicates the second halftone value is closer to the comparison halftone value than the first halftone value, selecting, for first individual ones of the second subset of pixels, the mask-based dithering technique.
(v) when the comparing indicates the second halftone value is not closer to the comparison halftone value than the first halftone value, selecting, for second individual ones of the second subset of pixels, the error diffusion technique.

22. The storage medium of claim 21, wherein computing the temporal CRM of each input pixel includes comparing a halftone value of the input pixel to a halftone value of a corresponding output pixel of a comparison frame.

23. The storage medium of claim 21, wherein computing the spatial CRM of each input pixel includes comparing a data value for the input pixel to a corresponding data value for neighboring input pixels, the neighboring input pixels and the input pixel being located in a common local region.

24. The storage medium of claim 21, wherein
the error diffusion technique includes quantizing the input pixel and diffusing a first quantization error with an error diffusion filter; and
the first quantization error includes a second quantization error resulting from the mask-based dithering halftoning technique.

25. The storage medium of claim 21, wherein the operations further include computing the second quantization error by clipping a quantization error resulting from the mask-based dithering halftoning technique.
